(19) United States
(12) Patent Application Publication
(10) Pub. No.: US 2009/0318129 A1
(43) Pub. Date: Dec. 24, 2009

(54) Mobile Communication Monitoring System

(76) Inventor: Alister Watt, McComb, MS (US)

Correspondence Address: NEUSTEL LAW OFFICES, LTD., 2534 SOUTH UNIVERSITY DRIVE, SUITE 4, FARGO, ND, 58103, US

(21) Appl. No.: 12/107,106

(22) Filed: Apr. 22, 2008

(51) Int. Cl. H04Q 7/20

(52) U.S. Cl. 455/423

(57) ABSTRACT

A mobile communication monitoring system for efficiently monitoring the usage of a mobile communications device within a vehicle. The mobile communication monitoring system generally includes a motion detector adapted for determining whether a vehicle is in motion, a controller connected to the motion detector, wherein the controller is adapted for determining whether a mobile communications device is in use while the vehicle is in motion and a conveying device connected to the controller, wherein the conveying device is adapted for conveying communication information relating to the usage of the mobile communications device to a guardian.

### CROSS REFERENCE TO RELATED APPLICATIONS

Not applicable to this application.

### STATEMENT REGARDING FEDERALLY SPONSORED RESEARCH OR DEVELOPMENT

Not applicable to this application.

### BACKGROUND OF THE INVENTION

1. Field of the Invention

The present invention relates generally to monitoring systems and more specifically it relates to a mobile communication monitoring system for efficiently monitoring the usage of a mobile communications device within a vehicle.

2. Description of the Related Art

Any discussion of the related art throughout the specification should in no way be considered as an admission that such related art is widely known or forms part of common general knowledge in the field.

Mobile communication devices have been in use for years and are becoming increasingly popular among almost all age groups. A dramatic increase in the number of mobile communication devices utilized is also present with teenagers. One particular area in which the usage of mobile communication devices is of a concern among individuals (e.g. teenagers, etc.) is within moving vehicles.

In particular, there is a concern that when drivers use the mobile communication devices for voice, text, internet browsing and other such communications while operating the moving vehicle they are distracted from safe driving and therefore such use creates an unacceptable risk to themselves and the public at large. Because of the inherent problems with the related art, there is a need for a new and improved mobile communication monitoring system for efficiently monitoring the usage of a mobile communications device within a vehicle and informing a guardian of the individual if there is substantial use of the mobile communication device while the user is driving.

### BRIEF SUMMARY OF THE INVENTION

The general purpose of the present invention is to provide a mobile communication monitoring system that has many of the advantages of the monitoring systems mentioned heretofore. The invention generally relates to a monitoring system which includes a motion detector adapted for determining whether a vehicle is in motion, a controller connected to the motion detector, wherein the controller is adapted for determining whether a mobile communications device is in use while the vehicle is in motion and a conveying device connected to the controller, wherein the conveying device is adapted for conveying communication information relating to the usage of the mobile communications device to a guardian.

There has thus been outlined, rather broadly, some of the features of the invention in order that the detailed description thereof may be better understood, and in order that the present contribution to the art may be better appreciated. There are additional features of the invention that will be described hereinafter and that will form the subject matter of the claims appended hereto.

In this respect, before explaining at least one embodiment of the invention in detail, it is to be understood that the invention is not limited in its application to the details of construction or to the arrangements of the components set forth in the following description or illustrated in the drawings. The invention is capable of other embodiments and of being practiced and carried out in various ways. Also, it is to be understood that the phraseology and terminology employed herein are for the purpose of the description and should not be regarded as limiting.

An object is to provide a mobile communication monitoring system for efficiently monitoring the usage of a mobile communications device within a vehicle.

Another object is to provide a mobile communication monitoring system that serves to deter a teenager from using a mobile communications device while operating a moving vehicle.

Another object is to provide a mobile communication monitoring system that notifies a guardian of the mobile communications user when customizable usage rules are violated.

An additional object is to provide a mobile communication monitoring system that may be utilized with various types of mobile communication devices, such as cell phone, smart phones and other such devices.

A further object is to provide a mobile communication monitoring system that may be utilized to monitor voice, text messages, internet browsing communications and other communications upon a mobile communication device.

Other objects and advantages of the present invention will become obvious to the reader and it is intended that these objects and advantages are within the scope of the present invention. To the accomplishment of the above and related objects, this invention may be embodied in the form illustrated in the accompanying drawings, attention being called to the fact, however, that the drawings are illustrative only, and that changes may be made in the specific construction illustrated and described within the scope of the appended claims.

### BRIEF DESCRIPTION OF THE DRAWINGS

Various other objects, features and attendant advantages of the present invention will become fully appreciated as the same becomes better understood when considered in conjunction with the accompanying drawings, in which like reference characters designate the same or similar parts throughout the several views, and wherein:

FIG. 1 illustrates a schematic of the components of the preferred embodiment illustrating the various components of the preferred embodiment communicating through the communication network.

FIG. 2 is a flowchart illustrating the process of the preferred embodiment, wherein the mobile communications device is being monitored.

FIG. 3 is a flowchart illustrating the steps involved in receiving updates from the controller that communications are and/or have occurred and taking action base on the match between the type of communication and the pre-defined rules for use of the mobile communications device.

FIG. 4 is a flowchart illustrating the steps in setting up the rules for monitoring and reporting the use of the mobile communications device.

FIG. 5 is a flowchart detailing the steps of receiving a self-service report of a specific mobile communications device.

### DETAILED DESCRIPTION OF THE INVENTION

### A. Overview

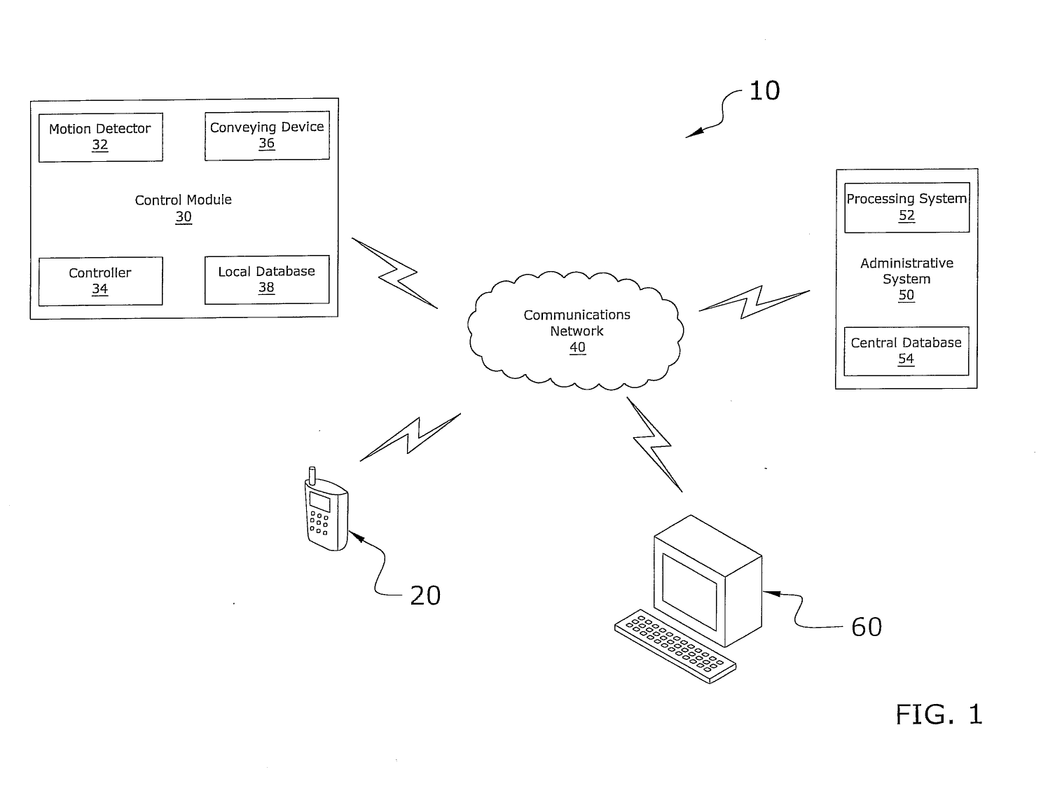

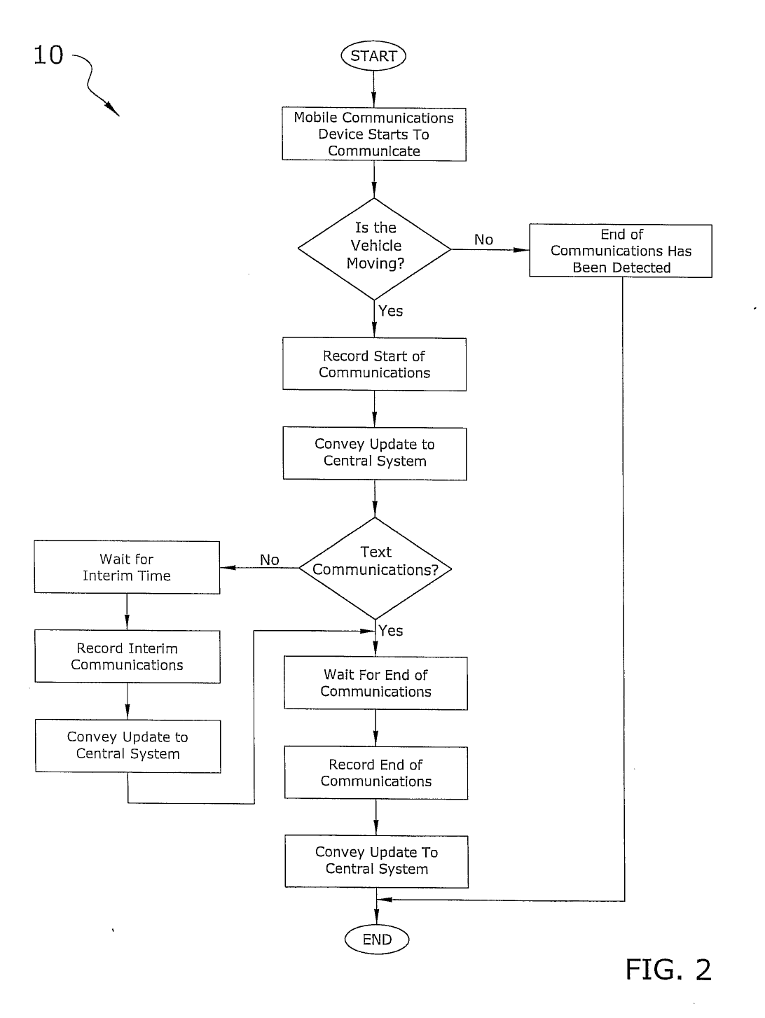

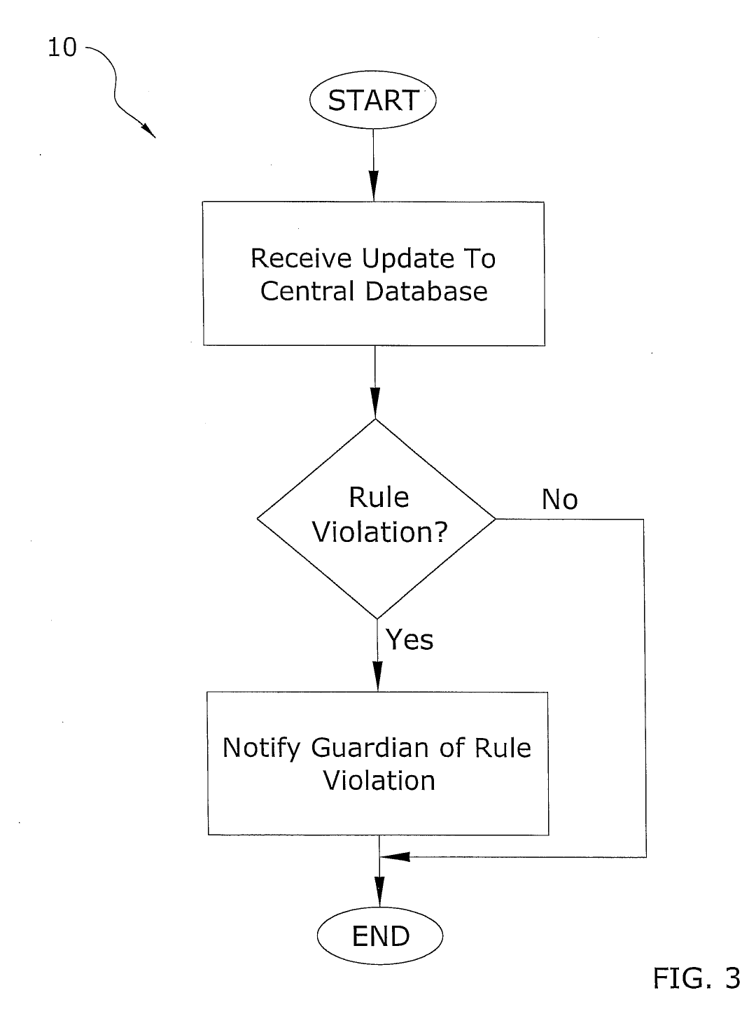

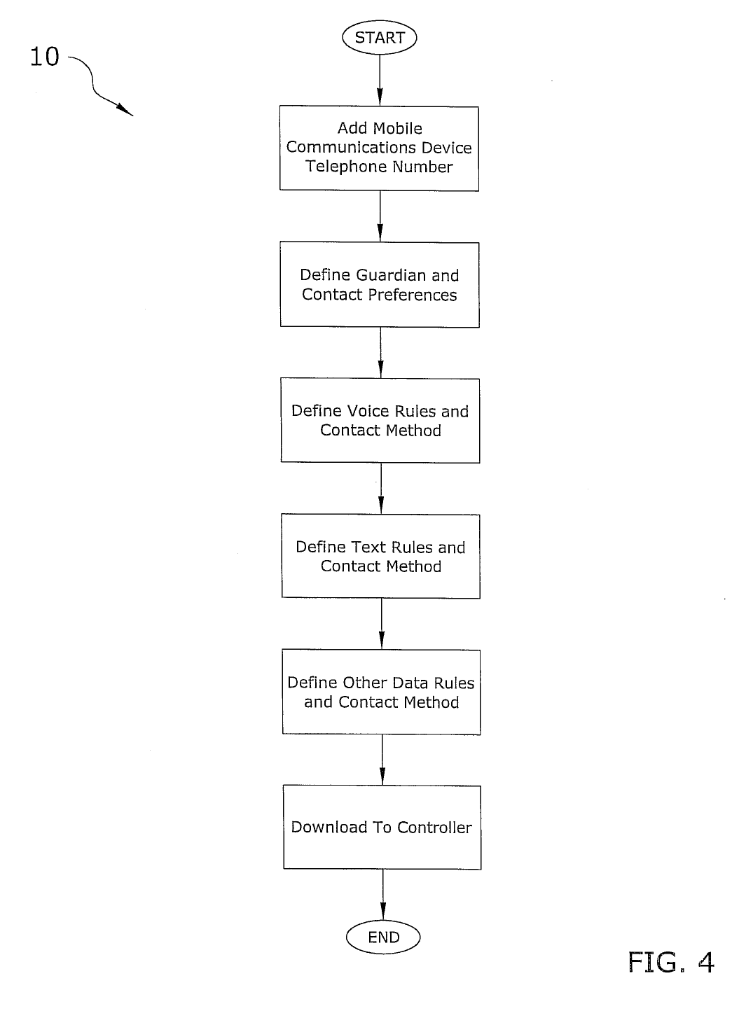

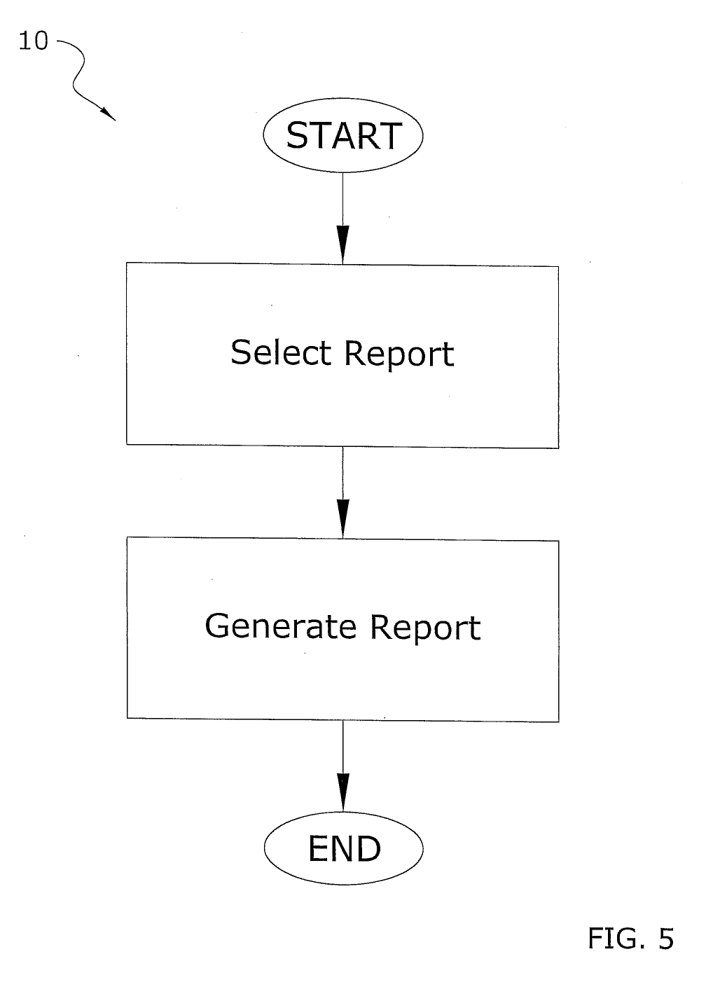

Turning now descriptively to the drawings, in which similar reference characters denote similar elements throughout the several views, FIGS. 1 through 5 illustrate a mobile communication monitoring system 10, which comprises a motion detector 32 adapted for determining whether a vehicle is in motion, a controller 34 connected to the motion detector 32, wherein the controller 34 is adapted for determining whether a mobile communications device 20 is in use while the vehicle is in motion and a conveying device 36 connected to the controller 34, wherein the conveying device 36 is adapted for conveying communication information relating to the usage of the mobile communications device 20 to a guardian.

### B. Mobile Communications Device

The mobile communications device 20 may be comprised of various types of communication devices, such as but not limited to cellular phones, pagers, PDAs, smart phones, two-way radios and various others. The mobile communications device 20 is able to receive and transmit communications, wherein the communications sent and received may be comprised of any type of data common to communication devices, such as text messages, voice calls, browsing data such as through the Internet, email or various others. In the preferred embodiment, the mobile communications device 20 is identifiable through a 10 digit number (i.e. phone number), wherein the 10 digit number is herein referred to as the mobile communications device identifier; however it is appreciated that the mobile communications device 20 may be identifiable through various other types or sequences of numbers, letters, characters, modes or characteristics.

The mobile communications device 20 also preferably transmits an information packet once communications start or end from the mobile communications device 20. The information packet is preferably transmitted over the communications network 40 to the controller 34 of the control module 30. The information packet is adapted to identify the mobile communications device 20 and the type and the duration of the communications (e.g. voice, text, Internet browsing, email, etc.).

### C. Information Packet

The information packet includes various types of information relating to the mobile communications device 20 and usage thereof. The information packet is transmitted by the mobile communications device 20 (or interpreted by the controller 34 to be the information packet) when communications are initiated to or from the mobile communications device 20 (i.e. first information packet) and also when communications end to or from the mobile communications device 20 (i.e. second information packet). The same information packet is also utilized between the vehicle and the processing system 52. The information packet preferably includes the following logical components.

i. Packet Identifier

The packet identifier is preferably utilized to tie the particular information packet series together. For example, the packet identifier is utilized to tie a first information packet (i.e. for recording a beginning of a communication) to a second information packet (i.e. for recording an ending of a communication). The packet identifier may also be utilized to tie an interim information packet to the first information packet and the second information packet.

ii. Mobile Communications Device Identifier

The mobile communications device identifier is preferably the 10 digit telephone number of the mobile communications device 20 if the mobile communications device 20 is comprised of a cellular phone. However, it is appreciated that various other device identifiers may be utilized to identify various other types of mobile communications device 20.

iii. Modal Positioner

In the preferred embodiment, the modal positioner preferably sets the information packet to either “Start”, “End”, or “Interim” depending upon which portion of the communication the information packet is utilized for. The “Start” position is utilized for the first information packet, the “End” position is utilized for the second information packet and the “Interim” position is utilized for the interim information packet. It is appreciated that in various embodiments, the modal positioned may be set to various other positions.

iv. Communications Type

In the preferred embodiment the communications type may be set to “Voice”, “Text”, or “Other Data” to indicate the type of mobile communications device 20 communications recorded in the information packet. It is appreciated that “Other Data” may include Internet browsing, email transmission, streaming video transmission and various other types of communication. It is appreciated that in various embodiments, the communications type may be set to various other positions.

v. Start Time Function

The start time function of the information packet records the start time of the mobile communications device 20 communications. It is appreciated that the start time function also preferably records the start date of the mobile communications device 20 communications.

vi. End Time Function

The end time function of the information packet records the end time of the mobile communications device 20 communications. It is appreciated that the end time function also preferably records-the end date of the mobile communications device 20 communications.

vii. Communications Duration

The communications duration function records the length of the communications that occurred while the vehicle was in motion. It is appreciated that the communications duration recorded may be shorter than the difference between the start time and the end time if the vehicle stopped at any time during the communication. The communications duration is analyzed by the processing system 52 to determine if the communications duration recorded violates any of the specified rules.

viii. Other Data

The information packet may also record various other types of data consistent with the need to record and report use of the mobile communications device 20 within a vehicle in motion. Such other data may include the identifier (e.g. 10 digit telephone number, other unique identifier) of the party being contacted or contacting the operator of the mobile communications device 20 that is being monitored.

### D. Control Module

The control module 30 preferably communicates information relating to data received or transmitted from the mobile communications device 20 to the administrative system 50. The control module 30 is preferably located within a close proximity to where the mobile communications device 20 is being overseen (i.e. monitored, detected). In the preferred embodiment, the control module 30 is positioned in or around the vehicle in which the mobile communications device 20 is being monitored. It is appreciated however that the control module 30 may include circuitry to allow the control module 30 to oversee the functioning of the mobile communications device 20 from far away distances. The control module 30 is also preferably positioned within a tamper proof enclosure within the vehicle so as to prevent the user of the mobile communications device 20 or anybody else from disturbing or deactivating the control module 30. The enclose also preferably includes a notification system in which to notify the guardian if the control module 30 or enclosure has been tampered with.

i. Motion Detector

The control module 30 includes a motion detector 32 to detect whether the vehicle is in motion at any given point in time. The motion detector 32 may be comprised of various configurations all which are able to detect whether the vehicle is in motion, such as but not limited to mechanics and electronics associated with a common vehicle speedometer, automatic door lock circuitry, a global positioning system or various others. If utilizing the mechanics and electronics associated with a common vehicle speedometer, it is appreciated that the current vehicle speedometer may be utilized or a newly installed (i.e. additional) speedometer unit may be utilized. Since the controller 34 is generally positioned within the vehicle, the motion detector 32 inherently determines if the controller 34 is moving with respect to the ground while determining if the vehicle is in motion.

ii. Controller

The control module 30 includes a controller 34. The controller 34 is preferably electrically connected to the motion detector 32, wherein the controller 34 receives information from the motion detector 32 on whether or not the vehicle is in motion. The controller 34 is also able to detect whether the mobile communications device(s) 20 is being utilized within the vehicle. The controller 34 is preferably either able to interpret existing communication signals initiated from or terminating at the mobile communications device 20 or a new protocol and wireless communications system is established between the controller 34 and the mobile communications device 20 to oversee the usage of the mobile communications device(s) 20.

The controller 34 also communicates with the administrative system 50 to transmit information packets received from the mobile communications device 20 to the administrative system 50. It is appreciated that the controller 34 is preferably programmed to be able to continually attempt to transmit the information packets to the administrative system 50 until the information packet is successfully sent to the administrative system 50, wherein the communication network may be “down”, the vehicle is in an area where the controller 34 is not able to communicate through the communications network 40, or not fully functional for various other reasons.

The controller 34 also preferably is able to determine when exactly a particular rule has been violated. The controller 34 is adapted to be able to send an interim update to inform the guardian that the rule has been violated even before the respective communications from the mobile communications device 20 is over. It is appreciated that the interim update need not generally apply to text messages because the sending or receiving of the text messages is of an extremely short duration, wherein the interim update generally applies only to voice communications, Internet browsing or longer duration communications.

iii. Conveying Device

The control module 30 also includes a conveying device 36. The conveying device 36 is preferably comprised of a wireless communications device. The conveying device 36 is electrically connected to the controller 34 and preferably conveys the usage data received by the controller 34 from the mobile communications device 20 to the administrative system 50. The conveying device 36 is also able to receive information from the administrative system 50 and processing system 52. The conveying device 36 further preferably conveys the data through the communications network 40. It is also appreciated that the conveying device 36 may be integrally formed with the controller 34 or other component of the control module 30.

iv. Local Database

The control module 30 also includes a local database 38. The local database 38 is in communication with the controller 34. The controller 34 preferably sends the information packets received by the mobile communications device 20 to the local database 38. The local database 38 subsequently records the information packets. The local database 38 also preferably receives and stores the information relating to the interim update.

The local database 38 also receives updated and preset guardian defined rules from the processing system 52 of the administrative system 50 via the conveying device 36 and the controller 34, wherein the conveying device 36 sends the received information to the controller 34 and the controller 34 sends the received information to the local database 38. It is appreciated that in the preferred embodiment the local database 38 is stored upon non-volatile memory.

### E. Communications Network

The communications network 40 may be comprised of various types of global or local networks in which a communication signal or other information may be transmitted. In the preferred embodiment, the communication network is comprised of a medium in which various frequencies utilized by various devices (e.g. cellular phones, etc.) may be transmitted. The communications network 40 may also be comprised of a private network or a public network. It is also appreciated that the present invention may include more than one communications network 40, such as a first communication network used by the controller 34, a second communication network used by the host computer and various other types of communication networks.

### F. Administrative System

The administrative system 50 is preferably located at a central or remote site from the vehicle. The guardian manages and controls the administrative system 50, wherein the administrative system 50 receives the information packets relating to the usage of the operator's mobile communications device 20 usage. The administrative system 50 is able to communicate with the control module 30 so as to receive information data packets from the control module 30 and transmit stored information relating to set rules to update the local database 38 of the control module 30.

i. Processing System

The administrative system 50 includes the processing system 52. The processing system 52 is preferably web-based and provides an interface for the guardian to register mobile communications devices 20 to be monitored and specify monitoring rules previously defined. The processing system 52 is in communication with the controller 34 of the control module 30 and preferably receives the information packets received by the controller 34 from the mobile communications device 20.

The information packets are preferably transmitted to the processing system 52 from the controller 34 through the communications network 40. The processing system 52 also checks the content of the information packets to determine if the recorded usage (i.e. content) of the mobile communications device 20 transferred in the information packet violates any of the preset rules. The processing system 52 is also able to update the central database 54 as needed. The processing system 52 is further accessed via the Internet by the notifying device 60.

ii. Central Database

The administrative system 50 also includes the central database 54. The central database 54 is preferably in communication with the processing system 52 and the central database 54 preferably records the information packets received by the processing system 52. Any rules created by the guardian are also preferably stored within the central database 54.

### G. Notifying Device

The notifying device 60 may be comprised of a host computer or other type of receiving device in which to receive the alerts by way of text message, email, voice message, etc. sent because of the violation of the rules set for the mobile communications device 20. A guardian is preferably in charge of the notifying device 60, wherein the guardian is able to read and acknowledge any alerts received by the host unit. The guardian may be comprised of various types of people that desire to oversee or monitor the usage of the operator's mobile communications device 20, such as but not limited to a supervisor, a parent, a teacher, a mentor, a friend, or various other individuals.

The guardian is able to access the central database 54 of the administrative system 50 through the notifying device 60 to alter and/or define any monitoring rules, wherein the guardian accesses the administrative system 50 through the communications network 40. The guardian is further able to generate self-service reports within the database 54. The self-service reports include but are not limited to reporting violations to the guardian of rules by communication type. The reports may be generated for the guardian upon demand, wherein the guardian may input any relevant parameters to receive a specific report.

### H. Rules

The guardian may desire to set one or more rules regarding the usage of the mobile communications device 20 by the operator. If the rules are violated by the operator of the mobile communications device 20, the guardian is subsequently alerted of the violation.

i. Setup

As stated previously, the rules are preferably set up by the guardian to work upon the operator's mobile communications device 20. When setting up the rules, the guardian first adds a mobile communications device identifier in the preferable form (i.e. 10 digit telephone number assigned to the mobile communications device 20) to the processing system 52 to store in the central database 54. Other identifying information such as the name of the operator who uses the mobile communications device 20 may also be stored.

The guardian then defines who they are and how they would like to receive the alerts from the system. The guardian also lists the various methods by which they may be contacted, such as email address, telephone number for voice, telephone number for text and any others available.

The guardian also defines the rules they desire to use to monitor the voice communications of the operator. The guardian may monitor inbound communications (to the mobile communications device 20) and/or outbound communications (from the mobile communications device 20). The guardian can also specific the threshold duration of the voice call that will trigger the alert. For example, the guardian may desire to receive alerts if any inbound calls occur that last more than one minute and separately monitor for all outbound calls not matter how long they last. The threshold duration is also utilized by the device to determine when to send an interim update to the processing system 52 to report a voice rule that has been violated.

The guardian also defines the rules they desire to utilize to monitor the use of text messaging. The guardian has the option of monitoring inbound and outbound text messages separately. The guardian also specifies which of the contact methods they desire to utilize for the each of the associated rules.

The guardian also defines the rules they desire to utilize to monitor the use of data communications (e.g. Internet browsing, email, etc.). The guardian can also specific the threshold duration of the data communications that will trigger the alert. The threshold duration is also utilized by the device to determine when to send an interim update to the processing system 52 to report a data communication rule that has been violated. The guardian also specifies which of the contact methods they desire to utilize for the each of the associated rules. All of the previously described information is subsequently uploaded to the controller 34, local database 38 and central database 54 once the guardian has finished entering in any desired information.

ii. Examples

Following are a plurality of example rules that the guardian may set; however it is appreciated that the rules may be modified to accommodate overseeing (i.e. monitoring, detecting) any type of data transmitted (i.e. any usage) from the mobile communications device 20 and the guardian may be monitored in various manners generally relating to the alert being transmitted over the communications network 40, such as through text message, voice message, email, or various other manners.

It is also appreciated that the vehicle referred to in the forthcoming examples is preferably equipped with the control module 30 or the control module 30 is programmed or set to monitor the particular vehicle that the operator is driving. It is appreciated that in alternate embodiments of the present invention, multiple vehicles may be monitored with the control module 30 to oversee the usage of one or more operator's mobile communications devices 20 (i.e. multiple mobile communications devices 20 may be monitored simultaneously).

An example of a first rule may be: the mobile communications device 20 operator (e.g. child, employee, etc.) may not use their mobile communications device 20 for outgoing text messages while the vehicle is in motion. The guardian may further specify to be notified by way of a voice message, text message or in another manner when the first rule has been violated.

An example of a second rule may be: the mobile communications device 20 operator may not browse the Internet on their mobile communications device 20 while the vehicle is in motion. The guardian may in this case desire to be notified by way of an email or other manner when the second rule is violated.

An example of a third rule may be: the mobile communications device 20 operator may not engage in voice conversations (incoming or outgoing) for more than one continuous minute or other length of time on their mobile communications device 20 while the vehicle is in motion. The guardian may in this case desire to be notified by way of an email or other manner when the third rule is violated.

### I. Operation of Preferred Embodiment

In use, the motion detector 32 first determines if the vehicle or controller 34 is stationary or moving at any point in time. Changes in the state (i.e. stationary or moving) of the controller 34 or vehicle are communicated to the controller 34. Once the controller 34 is informed that the vehicle is in motion by the motion detector 32, the controller 34 begins to monitor for the start of the mobile communications device 20 communications (i.e. data transmitted or received by the mobile communications device 20). It is appreciated that vehicle if a user takes a call (i.e. voice communications) with the mobile communications device 20 before entering the vehicle, starts the vehicle and sets forth while still on the call with the communications device 20, the controller 24 is adapted to detect such call.

When the mobile communications device 20 communications are initiated with a communications network 40, a first information packet is transmitted by the mobile communications device 20 on any available channel detectable by the controller 34 to indicate the start of a communication. The first information packet identifies the mobile communications device 20 and the type and the duration of the communications (e.g. voice, text, Internet browsing, email, etc.). The first information packet is subsequently recorded in the local database 38.

At this time the conveying device 36 is instructed by the controller 34 to communicate the same information packet to the processing system 52 of the administrative system 50 via the communications network 40. Once received by the processing system 52, the information packet is subsequently recorded within the central database 54. To accommodate timely reporting of lengthy voice or data communications by the operator of the mobile communications device 20, an interim update is sent to the processing system 52 by the controller 34 when and if any rule for the particular type of communication has been violated as opposed to waiting until the end of the communication to report the violation. The interim update is also preferably transmitted to and stored within the local database 38.

When the communication by the mobile communications device 20 has ended, an second information packet is transmitted by the mobile communications device 20 on any available channel detectable by the controller 34 to indicate the end of a communication. The second information packet includes much of the same information as the first information packet. The second information packet is also stored within the local database 38 and transmitted to the processing system 52 over the communications network 40 to also be stored within the central database 54. If the processing system 52 receives the first information packet and the second information packet during a time in which the vehicle was stationary the system resets and does not send any alerts.

The processing system 52 checks the first information packet and the second information packet to see if the content stored in either of the information packets violates any of the preset rules. The processing system 52 compares the content stored in the information packets to the rules within the central database 54. If a rule is violated (e.g. no outgoing text messages while the vehicle is in motion) the processing system 52 looks up the central database 54 for the contact preferences stored for the particular rule and the corresponding mobile communications device identifier.

The processing system 52 then establishes a connection to transmit the alert to the notifying device 60 and guardian through the communications network 40. Upon successful sending of the alert to the notifying device 60, the processing system 52 updates the central database 54 that the alert has been send. The local database 38 is also preferably updated when the central database 54 is updated via the alert information being transmitted to the conveying device 36 via the processing system 52 and then transferred over to the controller 34 which transfers the alert information to the local database 38. It is appreciated that the processing system 52 accounts for any duration of time that the vehicle was stopped during the duration of the communication when analyzing the communication to see if the communication violated a rule.

What has been described and illustrated herein is a preferred embodiment of the invention along with some of its variations. The terms, descriptions and figures used herein are set forth by way of illustration only and are not meant as limitations. Those skilled in the art will recognize that many variations are possible within the spirit and scope of the invention, which is intended to be defined by the following claims (and their equivalents) in which all terms are meant in their broadest reasonable sense unless otherwise indicated. Any headings utilized within the description are for convenience only and have no legal or limiting effect.

I claim:

1. A system for overseeing usage of a mobile communication device, comprising:
a motion detector adapted for determining whether a vehicle is in motion;
a controller connected to said motion detector, wherein said controller is adapted for determining whether at least one mobile communications device is in use while said vehicle is in motion; and
a conveying device connected to said controller, wherein said conveying device is adapted for conveying communication information relating to said usage of said at least one mobile communications device to a guardian.

2. The system for overseeing usage of a mobile communication device of claim 1, including an administrative unit communicatively connected to said conveying device.

3. The system for overseeing usage of a mobile communication device of claim 2, wherein said administrative unit includes a central database.

4. The system for overseeing usage of a mobile communication device of claim 3, wherein said central database stores at least one predefined rule relating to said usage of said at least one mobile communications device.

5. The system for overseeing usage of a mobile communication device of claim 4, wherein said administrative unit is accessed through the Internet to update said at least one predefined rule within said central database.

6. The system for overseeing usage of a mobile communication device of claim 1, including a local database communicatively connected to said controller.

7. The system for overseeing usage of a mobile communication device of claim 1, wherein said at least one mobile communications device is comprised of a cellular phone.

8. A system for overseeing usage of a mobile communication device, comprising:
a control module mounted to a vehicle, wherein said control module is adapted to receive usage information of a mobile communications device within said vehicle; and
an administrative unit located remotely from said control module; wherein said administrative unit communicates said usage information with said control module through a communication network;
wherein said administrative unit is adapted to alert a guardian of said usage information.

9. The system for overseeing usage of a mobile communication device of claim 8, wherein said control module includes a motion detector.

10. The system for overseeing usage of a mobile communication device of claim 8, wherein said mobile communications device transmits an information packet.

11. The system for overseeing usage of a mobile communication device of claim 10, wherein said information packet is transmitted to said administrative unit through said control module.

12. The system for overseeing usage of a mobile communication device of claim 8, wherein said administrative unit alerts said guardian if a predefined usage rule has been violated.

13. A method of overseeing a usage of a mobile communication device, comprising:
providing a mobile communications device;
using said mobile communications device to receive or transmit communications;
determining a proximity of said mobile communications device to a vehicle;
determining whether said vehicle is in motion; and
alerting a guardian of said usage of said mobile communications device.

14. The method of overseeing a usage of a mobile communication device of claim 13, including a step of transmitting said alert through a communication network to an administrative unit.

15. The method of overseeing a usage of a mobile communication device of claim 13, including a step of defining at least one rule relating to a usage of said mobile communications device.

16. The method of overseeing a usage of a mobile communication device of claim 15, wherein said at least one rule relates to voice calls.

17. The method of overseeing a usage of a mobile communication device of claim 15, wherein said at least one rule relates to text messages.

18. The method of overseeing a usage of a mobile communication device of claim 15, wherein said at least one rule relates to data communications.

19. The method of overseeing a usage of a mobile communication device of claim 13, including a step of sending an information packet from said mobile communications device when said mobile communications device receives or transmits communications.

20. The method of overseeing a usage of a mobile communication device of claim 19, wherein said information packet is sent at a start time of said communications of said mobile communication device and at an end time of said communications of said mobile communication device.
